(19) United States
(12) Patent Application Publication
(10) Pub. No.: US 2026/0309299 A1
(43) Pub. Date: Oct. 8, 2026

(54) COLORED PROJECTION BY MULTI-LENS ARRAY PROJECTOR

(71) Applicant: ams-OSRAM Asia Pacific Pte. Ltd., Singapore (SG)

(72) Inventors: Ian KILBURN, Langnau am Albis (CH); Vladimir GRUENDLING, Fuerstenfeld (AT)

(21) Appl. No.: 19/482,786

(22) PCT Filed: Jun. 19, 2024
(86) PCT No.: PCT/EP2024/067106

§ 371 Date: Nov. 10, 2025

(30) Foreign Application Priority Data
Jun. 27, 2023 (DE) 10 2023 116 867.3

(51) Int. Cl. F21S 43/20; B60Q 1/24; F21W 103/60

(52) U.S. Cl. CPC F21S 43/255; B60Q 1/247; B60Q 2400/40; B60Q 2400/50; F21W 2103/60

(57) ABSTRACT

The present disclosure relates to a multi-lens optical element including: a plurality of optical channels, wherein each optical channel is defined by a corresponding field lens and a corresponding imaging lens; a structured layer configured to define for each optical channel a partial projection to be projected via the optical channel to obtain a resulting projection via a superposition of the partial projections; and a light coloring layer disposed in at least one optical channel, wherein the light coloring layer is disposed to cover a first portion of the structured layer in correspondence of the at least one optical channel and leave a remaining portion of the structured layer in correspondence of the at least one optical channel free of the light coloring layer, and wherein the light coloring layer is configured to impose a predefined color on light.

### TECHNICAL FIELD

The present disclosure relates generally to an optical element including a plurality of lenses and adapted to provide a colored projection, and to a projection system including the adapted optical element.

### BACKGROUND

In general, pattern projection is gaining increasing attention in the recent years, in particular for automotive applications. Static or dynamic projections allow displaying various types of information on interior surfaces of the vehicle (e.g., on a windscreen) or on the ground in proximity of the vehicle, e.g. on the street. For example, a symbol may be projected on the road as a warning sign to the vehicles behind, e.g. to indicate a malfunction or an emergency situation. As another example, a so-called “welcome light carpet” may be projected to welcome the driver or the passengers as they reach the vehicle. The projected pattern serves thus as a cosmetic feature and also as a safety feature to illuminate the vicinity of the vehicle and assist the user, e.g. at night or to illuminate an irregular surface. A typical approach relies on arrays of microlenses used as projection lenses in a multi-channel configuration. The projections from each microlens superimpose with one another to create the desired projection in the far-field, e.g. on a projection surface. Improvements in pattern projection, and in particular in pattern projection via multi-lens optical elements, may thus be of particular relevance for the further advancement of several technologies.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1A shows a projecting optical element with a microlens array in a schematic representation;

FIG. 1B shows pattern projection via the projecting optical element in a schematic representation;

FIG. 2A shows a multi-lens optical element in a schematic representation according to various aspects;

FIG. 2B shows additional features of the multi-lens optical element in a schematic representation according to various aspects;

FIG. 2C shows an exemplary arrangement of lenses in the multi-lens optical element in a schematic representation according to various aspects;

FIG. 2D shows exemplary projected images obtained with the multi-lens optical element according to various aspects;

FIG. 3A shows exemplary configurations for disposing a light coloring layer in an optical channel of the multi-lens optical element in a schematic representation according to various aspects;

FIG. 3B shows an exemplary configuration for disposing light coloring layers in different optical channels of the multi-lens optical element in a schematic representation according to various aspects;

FIG. 4A to FIG. 4D show exemplary configurations for disposing light coloring layers in different optical channels of the multi-lens optical element in a schematic representation according to various aspects;

FIG. 5A and FIG. 5B show exemplary configurations for disposing light coloring layers in different optical channels of the multi-lens optical element to obtain a color gradient in a schematic representation according to various aspects; and

FIG. 6 shows a projection system including the multi-lens optical element in a schematic representation according to various aspects.

### DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects. Various aspects are described in connection with methods and various aspects are described in connection with devices (e.g., a multi-lens optical element, a projection system). However, it is understood that aspects described in connection with methods may similarly apply to the devices, and vice versa.

In general, projection systems capable of projecting light according to a predefined pattern are of great importance for a variety of applications. A prominent example is the use of projection systems in the automotive context, e.g. by integrating a projection system in the door of a vehicle, or in the headlamp of the vehicle. A common use of such projection systems is the creation of “welcome light carpets”, in which a cosmetic pattern is projected in the vicinity of the vehicle, e.g. including the brand of the vehicle's manufacturer, or a welcome message for the driver. Another example is the projection of information on an interior surface of the vehicle or in the vicinity of the vehicle, e.g. a warning symbol for the driver, or a warning symbol for the neighboring vehicles or for cyclists. Other application scenarios of projection systems may include industrial environments, e.g. to assist robots or drones within a factory, home environments, e.g. to project cosmetic light features, and the like.

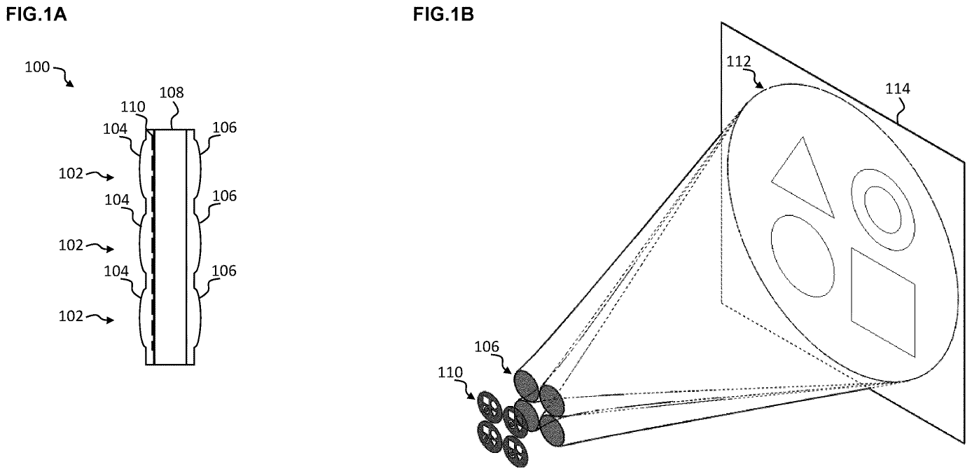

A usual approach for creating projections is based on so-called microlens arrays, as shown in FIG. 1A and FIG. 1B. A microlens-approach provides the possibility of having a compact projection module, e.g. with dimensions of a few cubic centimeters, thus facilitating integration in a host system, such as in the interior of a vehicle, in the door of a vehicle, in an automated machine, in a domestic appliance, and the like. In general, a projecting optical element 100 may include a plurality of optical channels 102 disposed in parallel with one another. The projections from each optical channel 102 superimpose with one another to create a full picture in the far-field. Considering a microlens-approach, the projecting optical element 100 may include a first array of microlenses at the illumination side, and a second array of microlenses at the projection side. Illustratively, the projecting optical element 100 may include a plurality of field lenses 104 and a plurality of imaging lenses 106 defining the optical channels 102. The first array of microlenses and the second array of microlenses may be disposed on an optical substrate 108, e.g. a glass substrate.

The projecting optical element 100 may further include a projection mask 110 that includes for each optical channel 102 a corresponding structure that defines the projection from that optical channel. The structures of the projection mask corresponding to the different optical channels 102 are configured to provide a desired projection 112 in the far-field, e.g. on a projecting surface 114 (such as a screen, a road, a wall, and the like), as shown in FIG. 1B. Illustratively, the structures of the projection mask corresponding to the different optical channels 102 are configured such that their superposition generates the final projection 112.

A microlens-approach makes it possible to achieve high brightness and sharp projections while enabling a reduction of the overall dimensions of the projecting optical element and of an associated module including also a light source, e.g. compared to a single-channel projector. The multi-channel configuration allows enhancing the brightness and the sharpness of the image thanks to the superposition of the multiple projections, while the small length and diameter of the individual lenses allows miniaturizing the system to facilitate its integration in a host device. The reduced dimension of a microlens compared to a conventional lens, e.g. about one-hundred times smaller, leads to a larger depth of focus (illustratively, a long focal depth) that enables combining the multiple projections in the far-field.

Despite the many advantages, a microlens-based projection system has shortcomings when it comes to the projection of colored patterns or colored images. In a conventional configuration, this type of projection requires a more complex system, or presents some limitations that reduce the overall flexibility of the operation of the projection system. As an example, colored projections may be achieved by employing light sources of different colors, e.g. light-emitting diodes (LED) emitting red light, green light, and blue light. However, such solution requires the use of multiple light sources, thus increasing the costs, area, and maintenance efforts for the system. As another example, an optical channel may be completely coated with a coating to impose a certain color onto the light propagating through that optical channel. However, the complete coating of the optical channel defines a rather static configuration that does not exploit the full potential of the multi-channel approach.

The present disclosure may be based on the realization that a partial coating of an optical channel in a multi-lens arrangement to impose a coloring on the light propagating through that optical channel enables a wide range of configurations for the resulting projection, thus enhancing the capabilities of a projection system compared to a configuration with a full coating for the optical channel, and without the need for additional (colored) light sources. Illustratively, the present disclosure may be based on the realization that placing a light coloring layer just in a dedicated part of the optical channel (e.g., just in a dedicated part of the aperture of a field lens) provides a simple, yet efficient strategy to tailor the appearance of the resulting projection.

According to the strategy proposed herein, in a multi-channel configuration for light projection an optical channel (or more than one optical channel, e.g. each optical channel) may include one or more light coloring layers in dedicated portions of the optical channel. The light coloring layers within the optical channel, alone or in combination with light coloring layers in one or more other optical channels, may be configured according to a desired (target) configuration for the resulting projection (also referred to as final projection), e.g. to provide color combinations, color gradients, etc. The proposed approach enables thus a more flexible and more granular adaptation of the resulting projection, e.g. to achieve complex color patterns, complex color gradients, etc.

According to various aspects, a multi-lens optical element may include: a plurality of optical channels, wherein each optical channel is defined by a corresponding field lens and a corresponding imaging lens; a structured layer configured to define for each optical channel an image to be projected via the optical channel; and a light coloring layer disposed in at least one optical channel of the plurality of optical channels, wherein the light coloring layer is disposed to cover a first portion of the structured layer in correspondence of the at least one optical channel and leave a second portion of the structured layer in correspondence of the at least one optical channel free of the light coloring layer, and wherein the light coloring layer is configured to impose a predefined color on light passing through the light coloring layer.

According to various aspects, a multi-lens optical element may include: a first lens array with a plurality of field lenses; a second lens array with a plurality of imaging lenses, wherein each field lens is associated with a corresponding imaging lens to define an optical channel; a projection mask configured to define a projection pattern for the optical channels; and a color filter disposed in a dedicated part of the aperture of at least one field lens but not over the entire aperture of the at least one field lens.

In a preferred configuration the multi-lens optical element may include a plurality of microlenses, e.g. a first array of microlenses at the illumination side (as field lenses) and a second array of microlenses at the projection side (as imaging lenses). Microlens arrays provide a convenient implementation of the proposed projection strategy, e.g. in terms of reduced dimension of the optical module, brightness of the resulting pattern, and well-established fabrication techniques. Therefore, in the following some of the terminology may pertain to the specific context of microlenses and microlens arrays (MLAs). It is however understood that in principle the proposed approach may be implemented with lenses that are not necessarily “micro”-lenses, e.g. with lenses with a larger diameter, e.g. larger than 1 mm.

The strategy proposed herein may be of particular relevance in the automotive context, e.g. for integration in a vehicle to allow projecting various images or patterns such as warning symbols, instructions to a driver, welcome carpets, and the like. Therefore, in the following some of the terminology may pertain to the specific context of automotive applications, e.g. in relation to possible host devices for the multi-lens optical element or for a corresponding projection system. It is however understood that in principle a multi-lens optical element or projection system configured as described herein may be for use in any suitable scenario in which image/pattern projection may play a role. Other application examples may include the industrial market (e.g., as part of an automated factory), the house market (e.g., as part of a smart domestic appliance), or in general the consumer market (e.g., as part of a portable device).

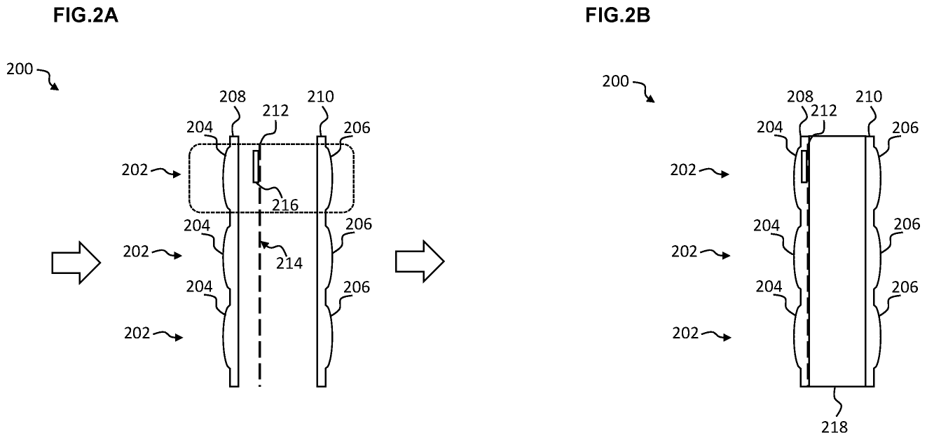

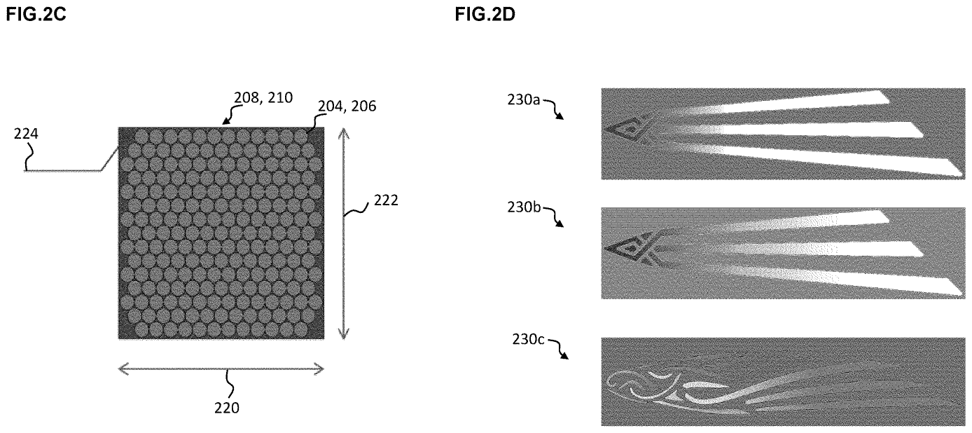

FIG. 2A shows a multi-lens optical element 200 configured according to the strategy proposed herein, in a schematic representation, according to various aspects. In general, the multi-lens optical element 200 may include a plurality of lenses defining a plurality of optical channels for projecting a pattern, and may include a light coloring layer in a dedicated portion of at least one optical channel. The multi-lens optical element 200 may also be referred to herein as multi-lens projector, multi-channel optical element, or multi-channel projector. For the sake of brevity the multi-lens optical element 200 may also be referred to simply as optical element 200. In general, the multi-lens optical element 200 may be configured to provide a colored projection, e.g. as part of a projection system, as discussed in further detail below.

In general, the multi-lens optical element 200 may include a plurality of optical channels 202 defined by corresponding pair of lenses 204, 206. In this context, the term “optical channel” may be used to describe a portion of the optical element 200 that contributes to the projection of a predefined resulting projection (a resulting pattern or image). An “optical channel” may thus indicate a portion of the optical element 200 defining a corresponding portion of the resulting projection (illustratively, a partial projection, e.g. a partial image or partial pattern) to define the resulting projection in combination with the other optical channels. Illustratively, an “optical channel” may be a part of the multi-lens optical element 200 through which light propagates to project a corresponding projection that in combination with the projections projected via the other optical channels forms a resulting projection (e.g., in the far-field).

As mentioned, each optical channel 202 may be defined by a corresponding pair of lenses 204, 206. In this regard, the optical element 200 may include a (first) plurality 208 of first lenses 204 and a (second) plurality 210 of second lenses 206. Each first lens 204 may define a respective optical channel 202 in combination with a corresponding second lens 206. In general, a first lens 204 and the corresponding second lens 206 may be arranged with respect to one another such that during an operation of the optical element 200 light propagates through one of the lenses (e.g., the first lens 204) and then through the other one of the lenses (e.g., the second lens 206). For example, a first lens 204 may be coaxially aligned with the corresponding second lens 206.

In principle, any suitable arrangement of the first lenses 204 and second lenses 206 may be provided depending on system considerations, e.g. a geometry of a projection system, space constraints of a host device, and the like. For example, the first lenses 204 and the second lenses 206 may be disposed in a one-dimensional arrangement, e.g. a one-dimensional array, such as in a column or a row of lenses. As another example, the first lenses 204 and the second lenses 206 may be disposed in a two-dimensional arrangement, e.g. in a two-dimensional array. In principle, the first lenses 204 and the second lenses 206 may be disposed in a regular arrangement (e.g., a periodic array) or an irregular arrangement (e.g., a non-periodic array, or any irregular disposition in a plane), as long as pair of lenses 204, 206 define respective optical channels. As an example, the first lenses 204 and/or the second lenses 206 may be arranged in a square array, a rectangular array, a hexagonal array, a circular array, an elliptical array, and the like.

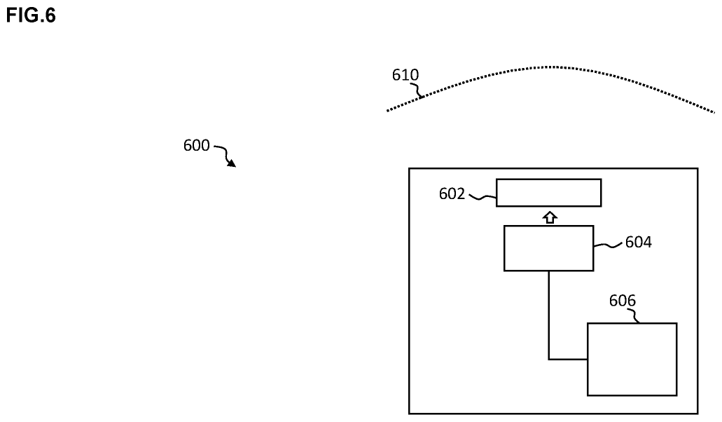

The first lenses 204 may also be referred to herein as illumination lenses, field lenses, or entrance lenses. Illustratively, during an operation of the optical element 200 the first lenses 204 may be disposed optically upstream in relation to incoming light with respect to the second lenses 206, so that light used to illuminate the optical element 200 (for creating the desired projection) impinges first on the first lenses 204 and then propagates to the second lenses 206. Stated differently, in operation (e.g., within a projection system, see also FIG. 6) the first lenses 204 may be disposed closer to the light source with respect to the second lenses 206.

In a corresponding manner, the second lenses 206 may also be referred to herein as projection lenses, imaging lenses, or exit lenses. Illustratively, during an operation of the optical element 200 the second lenses 206 may be disposed optically downstream in relation to incoming light with respect to the first lenses 204. Stated differently, in operation (e.g., within a projection system, see also FIG. 6) the second lenses 206 may be disposed closer to the field of illumination (and farther away from the light source) with respect to the first lenses 204.

In general, the first lenses 204 and the second lenses 206 may have any suitable configuration to provide projection of a predefined pattern/image. The first lenses 204 and second lenses 206 may be configured as spherical lenses or aspherical lenses. For example, at least one first lens 204 (e.g., each first lens 204) may be configured as a convex lens, e.g. as a plano-convex lens. As another example, at least one second lens 206 (e.g., each second lens 206) may be configured as a convex lens, e.g. as a plano-convex lens, e.g. with the convex surface facing in the opposite direction with respect to the convex surface of the first lenses 204. It is however understood that also other configurations for the lenses 204, 206 may be provided to achieve pattern/image projection.

In some aspects, the first lenses 204 may have the same configuration with respect to one another, e.g. the same parameters such as size, focal length, etc. In other aspects, one or more lens parameters may vary throughout the plurality of first lenses 204 (e.g., to compensate for distortions or other effects that may occur in the projection). In a corresponding manner, the second lenses 206 may have the same configuration with respect to one another, or in other aspects one or more lens parameters may vary throughout the plurality of second lenses 206.

In a preferred configuration, the first lenses 204 and the second lenses 206 may be microlenses. The term “microlens” may be used herein as commonly understood in the art to indicate a lens element with dimensions in the micrometer range, e.g. a lens element with a lateral dimension (e.g., a diameter) less than 1 millimeter (mm). In this configuration, a lens 204, 206 may also be referred to as “lenslet”. In this scenario the first plurality 208 of lenses 204 may thus be a first microlens array, and the second plurality 210 of lenses 206 may be a second microlens array. For example, the optical element 200 may include a first two-dimensional array of first microlenses (as field lenses) and a second two-dimensional array of second microlenses (as imaging lenses) defining the optical channels 202.

A microlens-based configuration provides projection capabilities with an overall reduced dimension, thus facilitating the integration of the optical element 200 and corresponding projection system in any suitable host device (e.g., in a headlamp, a door of a vehicle, and the like). A microlens may be fabricated with techniques known in the art, e.g. via molding, micro-machining, wafer-level fabrication techniques, and the like. A lens 204, 206, e.g. configured as microlens, may include or may be made of any suitable material, such as glass, an organic polymer, an inorganic polymer, etc. For example, a microlens may include or may be made of poly(methyl methacrylate), PMMA. In some aspects, a lens 204, 206 may be manufactured via polymer-on-glass fabrication (e.g., on a substrate that includes or is made of glass, see also FIG. 2B). In this configuration, the lens 204, 206 may be a hybrid glass-polymer lens, in which the robustness of the substrate enhances the stability of the lens and facilitates the handling during the fabrication. In other aspects, a lens 204, 206 may be a monolithic polymer lens (e.g., on a substrate that includes or is made of a polymer, e.g. a UV-curable polymer), which may provide reducing the number of fabrication steps.

The dimension of the lenses 204, 206 may be adapted in any suitable range, e.g. according to system considerations. In a preferred configuration, at least one lens 204, 206 (e.g., each first lens 204 and/or each second lens 206) may have a lateral extension in the direction perpendicular to the optical axis of the optical element 200 (e.g., a diameter) in the range from 1 μm (micometer) to 1000 μm, for example in the range from 5 μm to 500 μm, for example in the range from 10 μm to 300 μm. As another numerical example, at least one lens 204, 206 (e.g., each first lens 204 and/or each second lens 206) may have a lateral extension in the direction parallel to the optical axis of the optical element 200 (e.g., a thickness, or a height) in the range from 1 μm to 200 μm, for example in the range from 5 μm to 100 μm, for example in the range from 10 μm to 50 μm. It is however understood that in principle the strategy proposed herein may also be implemented with lenses of larger size, e.g. with a diameter greater than 1 mm and/or with a height greater than 1 mm.

The number of lenses 204, 206 may be adapted in any suitable range, e.g. according to system considerations. Only as a numerical example, the first plurality 210 of first lenses 204 and the second plurality of second lenses 206 may include a respective number of lenses in the range from 2 to 10⁶ (one million), for example in the range from 10 to 10⁵ (one hundred thousand), for example in the range from 100 to 10⁴ (ten thousand).

In general, the first lenses 204 and corresponding second lenses 206 may be disposed in any suitable arrangement that provides a superposition of the light (and corresponding partial pattern) projected via the various optical channels 202. Illustratively, the first lenses 204 and the second lenses 206 may be configured such that the light projected via the optical channels 202 superimpose to obtain a predefined projection in the far-field. Each optical channel 202 may project a different image/pattern/graphic/display and the final projection includes the superposition of the individual projections from each optical channel 202.

As an exemplary configuration, neighboring first lenses 204 (e.g., within the one-dimensional or two-dimensional array) may be in contact with one another, and/or neighboring second lenses 206 may be in contact with one another. As a numerical example, a center-to-center distance between neighboring (in other words, adjacent) first lenses 204, e.g. an array pitch of the first array, may be in the range from 10 μm to 1000 μm, for example in the range from 50 μm to 500 μm. In a corresponding manner, a center-to-center distance between neighboring second lenses 206, e.g. an array pitch of the second array, may be in the range from 10 μm to 1000 μm, for example in the range from 50 μm to 500 μm.

The optical element 200 may further include a structured layer 212 configured to define for each optical channel 202 an image/a pattern to be projected via the optical channel 202, illustratively a partial projection to be superimposed with the partial projections from the other optical channels 202 to obtain the resulting projection. Illustratively, the structured layer 212 may include structured features 214 in correspondence of each optical channel 202 to shape the light propagating through that optical channel 202 according to the structured features 214. For example, the structured features 214 may be clear opening through which light may freely pass. The structured layer 212 may thus be configured, for each optical channel 202, to partially block light and partially allow light to pass through the structured features 214 during an operation of the optical element 200. The structured features 214 may thus define apertures to project light via the corresponding optical channel 202 according to the shape and the arrangement of the structured features 214. The structured layer 212 may thus be opaque or non-transmissive at least for light in a predefined wavelength range, i.e. the wavelength range in which the optical element 200 (or the corresponding projection system) should operate, e.g. the wavelength range of light emitted by a light source of the projection system. The structured layer 212 may also be referred to herein as projection mask, and the structured features 214 may also be referred to herein as patterned features, or projection features. As an exemplary material, the structured layer 212 may include or may be made of a metal, such as chrome (e.g., black chrome).

As known in the art, the structured features 214 corresponding to each optical channel 202 may be adapted according to the resulting projection to be obtained in the far-field. The structured features 214 may be configured based on algorithms or simulations to find the configuration of the structured features 214 for each optical channel 202 (e.g., in terms of shape, arrangement, size, and the like) such that the superposition of the partial projections from the optical channels 202 generates the desired resulting (final) projection. Display for each optical channel 202 may be calculated separately, according to optical setup and geometrical setup. The structured features 214 corresponding to different optical channels 202 may thus be equal to one another or may vary slightly (e.g., gradually throughout the array) depending on the target resulting configuration for the projection. In principle, the structured layer 212 may be disposed at any suitable position within the optical element 200 to define the partial projections for the optical channels 202. As an example, the structured layer 212 may be disposed between the first lenses 204 and the second lenses 206 as shown in FIG. 2A.

In principle the structured layer 212 may be configured to define any type of projection to be achieved via the optical element 200. In general, the structured layer 212 may be configured to define an image to be projected via the optical channels 202 (e.g., by defining a partial image for each optical channel 202). An “image” may be any suitable graphic representation that may be projected via the optical element 202. In general, the optical element 200 may be illuminated with visible light and may define a colored projection in the visible spectral range, but it is understood that the aspects discussed herein may apply in a corresponding manner to the scenario in which the optical element 200 is illuminated with light that is invisible to the human eye (e.g., infrared light). Thus, reference to the “projection”, or to a “visual” or “graphic” nature of the projection may apply both to the case in which the projection is actually visible to the human eye and to the case in which the projection is invisible to the human eye (e.g., in case the projection is used for sensing processes, such as face recognition, object recognition, and the like).

The “image” to be projected may be configured (e.g., designed) according to the intended application of the optical element 200. As an example, the image defined by the structured layer 212 may represent a warning symbol, e.g. indicating the malfunction of a vehicle, a dangerous road condition, a velocity limit, and the like, e.g. to be projected on the road to warn the driver of a vehicle or drivers of neighboring vehicles. As another example, the image defined by the structured layer 212 may be a cosmetic image, e.g. representing the logo of a vehicle's manufacturer, a welcome message to the driver of a car, or simply a cosmetic pattern. In a different type of application, the image defined by the structured layer 212 may represent an instruction to be executed (e.g., “stop”, “go”, “turn left/right”, “jump”, etc.), a direction to be followed (e.g., as an arrow), a status information, or any suitable visual representation of information.

In some aspects, the projection may be a “pattern”. A “pattern” may include a repeated (regular) arrangement of features. For example a “pattern” may be a geometric pattern including geometric shapes that repeat in one-dimension or two-dimensions. In some aspects the “image” or “pattern” defined by the structured layer 212 may include a regular arrangement of features or elements, e.g. disposed in a grid or in any suitable regular arrangement. References herein to an “image” may apply in a corresponding manner to a “pattern”, and vice versa, or in general to any type of projection that may be obtained with the multi-lens optical element.

According to the strategy proposed herein, the optical element 200 may further include, in at least one optical channel 202, a light coloring layer 216. In general, a “light coloring layer” as described herein may be a layer configured to impose a predefined color on light passing through the layer. Illustratively, a “light coloring layer” may be configured to receive input light having a first color (or, for example, white light) and may be configured to deliver output light having a second color defined by the properties of the light coloring layer. A “light coloring layer” may thus be configured such that light output from the “light coloring layer” has a predefined color (e.g., has a wavelength in a predefined range).

In some aspects, a “light coloring layer” may be configured to select a predefined wavelength of light passing through the light coloring layer. In some aspects, the light coloring layer thus be configured as a color filter to allow light with wavelength in a predefined wavelength range to pass through the light coloring layer while blocking light with wavelength outside of the predefined wavelength range. For example, considering the scenario in which the optical element 200 is illuminated with white light, the light coloring layer may receive the white light as input light, and may deliver light with a specific color as output light (e.g., red, green, blue, etc.). As an example, a light coloring layer may be configured as bandpass color filter. As another example, a light coloring layer may be configured as low-pass color filter.

According to the configuration proposed herein, the light coloring layer 216 may be disposed only in a dedicated part of the optical channel 202. Illustratively, the light coloring layer 216 may be disposed in a dedicated region through which light propagates within the optical channel 202 but not over the entire region through which light propagates within the optical channel 202. The light coloring layer 216 may thus be disposed to cover a first portion of the structured layer 212 in correspondence of the at least one optical channel 202 while leaving a second portion of the structured layer 212 in correspondence of the at least one optical channel 202 free of the light coloring layer 216. The light coloring layer 216 may illustratively overlap with just a portion of the structured layer 212 in correspondence of the at least one optical channel 202.

Stated differently, the light coloring layer 216 may be disposed to cover one or more structured features 214 of the structured layer 212 in correspondence of the at least one optical channel 202, while leaving one or more further structured features 214 of the structured layer 212 in correspondence of the at least one optical channel 202 free of the light coloring layer 216. As another example, the light coloring layer 216 may overlap a portion of one structured feature while leaving another portion of the structured feature free of the light coloring layer 216. The light coloring layer 216 may thus be configured (and disposed) to color only part of the light that propagates through the optical channel 202, e.g. only light that passes through part of the structured features 214 to color only part of the partial projection of the optical channel 202 with the color defined by the light coloring layer 216. In some aspects, the light coloring layer 216 may be disposed in a portion of the aperture of the field lens 204 corresponding to the optical channel 202, while leaving another portion of the aperture of the field lens 204 free of the light coloring layer 216.

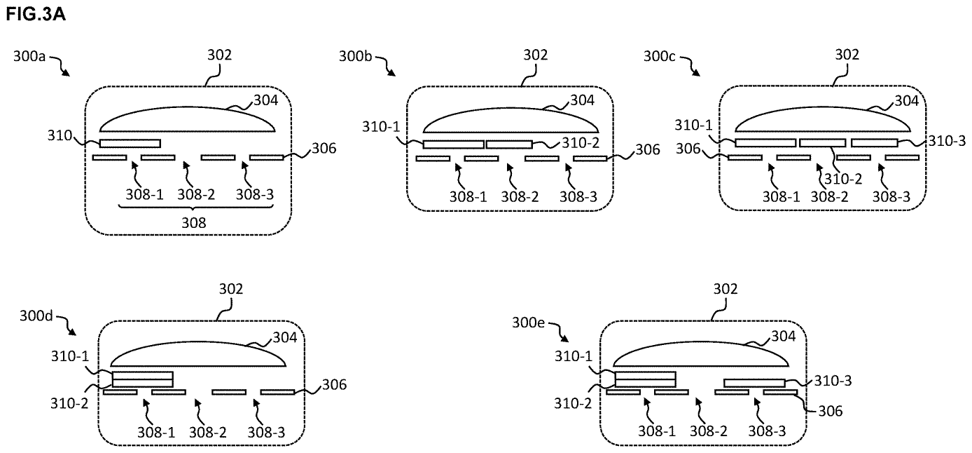

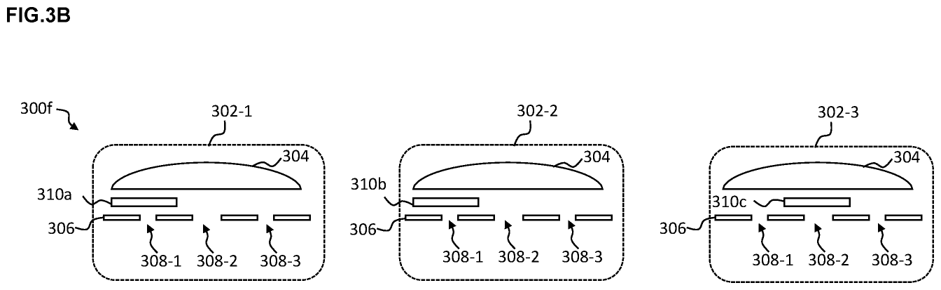

As mentioned above, disposing the light coloring layer 216 in only part of the optical channel 202 may provide additional freedom to design the outcome of the projection, as discussed in further detail below (see the various configurations in FIG. 3A to FIG. 5B). It is understood that the configuration in FIG. 2A is simplified for the purpose of illustrating the principles of the proposed strategy, and the optical element 200 may include more than one light coloring layer 216, e.g. in the same optical channel 202 or in different optical channels 202 (e.g., in each optical channel 202), as discussed in further detail below.

In principle, the light coloring layer 216 (and further light coloring layers) may be disposed at any suitable position within the optical element 200 to color light passing through the corresponding portion of the optical channel 202. In an exemplary configuration, a light coloring layer 216 may be disposed on the structured layer 212 in correspondence of the at least one optical channel 202. For example, the light coloring layer 216 may be formed directly on the structured layer 212, e.g. via deposition, patterning, curing, etc. In another exemplary configuration, a lens 204, 206 (e.g., each lens 204, 206) of the optical element 200 may include a base layer and a lens portion disposed over the base layer (e.g., in case of a microlens), and the light coloring layer 216 may be disposed on the base layer, illustratively to overlap with a part of the lens portion (but not with the entire surface of the lens portion). In an exemplary configuration, the light coloring layer 216 may be disposed between the first lens 204 and the second lens 206 defining the optical channel 202, e.g. between the first lens 204 and the structured layer 212.

In general, a light coloring layer may include or may be made of any suitable material capable of providing the light coloring properties of the layer. In a preferred configuration that allows a simple, yet efficient fabrication process, a light coloring layer may include or may be made of a resin material, e.g. an epoxy. It is however understood that also other materials may be used, e.g. a thin film material, plastic, resist material, etc. In an exemplary configuration, the light coloring layer may include or may be made of the same material as the first lens 204 and/or the second lens 206 defining the optical channel 202, thus providing a simpler fabrication process.

In the configuration in FIG. 2A, a single structured layer 212 is illustrated. It is however understood that the aspects discussed herein may apply in a corresponding manner to a configuration with more than one structured layer 212, e.g. with a stack of structured layers, or with a plurality of structured layers 212 disposed in sequence. In this scenario, the light coloring layer may be disposed at any suitable position within the sequence (or stack) of structured layers, depending on which structured features to color. A light coloring layer may be disposed before the first structured layer 212 in the sequence, after the last structured layer 212 in the sequence, or at any position within the sequence of structured layers 212.

It is also understood that the optical element 200 may include further components with respect to those shown. For example, the optical element 200 may include further lenses disposed optically upstream first lenses 204 or downstream of the second lenses 206, e.g. the optical element 200 may be part of a system with further optical elements such as lenses, mirrors, apertures, and the like. As another example, the first lenses 204 and/or the second lenses 206 may have anti-reflection properties, e.g. the first lenses 204 and/or the second lenses 206 may include an anti-reflection layer or coating. For example, the first lenses 204 and/or the second lenses 206 may include anti-reflection structures formed in the lens surface, e.g. moth-eye structures, nano-pillars, nano-rods, and the like.

FIG. 2B to FIG. 2D show further aspects related to the optical element 200. According to various aspects, as shown in FIG. 2B, the optical element 200 may further include an optical substrate 218. In this configuration, the first lenses 204 may be disposed on a first surface of the optical substrate 218 and the second lenses 206 may be disposed on a second surface of the optical substrate 218, opposite to the first surface (e.g., along the direction of the optical axis of the optical element 200). The first surface and the second surface may be main surfaces of the substrate 218, e.g. with lateral dimensions greater than a thickness of the substrate 218. The substrate 218 may be provided, for example, for some fabrication processes in which the lenses 204, 206 are formed (e.g., replicated) on the substrate 218, or in which a layer including the lenses 204, 206 (e.g., a PMMA layer) is disposed on the substrate 218.

In this configuration, the structured layer 212 may be disposed on the substrate 218. In a preferred configuration, the structured layer 212 may be disposed on the first surface of the optical substrate 218, illustratively between the first lenses 204 and the substrate 218. This configuration avoids beam clipping caused by the structured layer 212 following a beam expansion in the substrate 212. It is however understood that the structured layer 212 may be disposed at other positions. In a corresponding manner, the light coloring layer 216 may be disposed on the substrate 218 (e.g., on the structured layer 212 disposed on the substrate 218). For example, the light coloring layer 216 may be on the first surface of the optical substrate 218, illustratively between the first lenses 204 and the substrate 218.

The substrate 218 may include or may be made of any suitable refractive material, such as a glass (e.g., borosilicate glass or alumina borosilicate glass), optical filter glass, an epoxy, a polymer, and the like. In some aspects, the substrate 218 may be a wafer, e.g., a glass wafer, an epoxy wafer. As other examples, the substrate 218 may include or may consist of an oxide, a nitride, an oxynitride, and the like. In general the substrate 218 may be configured to allow transmission of light, e.g. in the wavelength range in which the optical element 200 operates. Illustratively, the substrate 218 may be configured to allow light (with wavelength in the predefined range) to pass through. As an example, the predefined wavelength range may be the visible range. As other examples, the wavelength range may be the infrared and/or near-infrared range, or any other suitable range. In some aspects, the optical substrate 218 may be configured to filter out light with wavelength outside the predefined wavelength range. For example, the material of the substrate 218 may be transmissive only in the desired wavelength range. As another example, the optical substrate 218 may have a coating configured to block light with wavelength outside the predefined wavelength range. In general, the dimensions of the optical substrate 218 may be adapted based on the desired use case, e.g. based on the overall dimensions of the optical element 200 or of the corresponding imaging device in which the optical element 200 is integrated.

In this regard, FIG. 2C shows an exemplary configuration for the disposition of the lenses 204, 206 and exemplary dimensions for the optical element 200 (and, accordingly, for the substrate). Illustratively FIG. 2C shows a possible configuration for the first array of lenses and/or the second array of lenses of the optical element. As exemplary dimensions (in a plane perpendicular to the optical axis of the optical element 200) the array of lenses (e.g., the substrate 218) may have a first dimension 220, e.g. a first width or length, in the range from 1 mm to 50 mm, for example in the range from 5 mm to 20 mm, for example a width/length of about 11 mm. As another numerical example, the array of lenses (e.g., the substrate 218) may have a second dimension 222 in the plane, e.g. a second width or length, in the range from 1 mm to 50 mm, for example in the range from 5 mm to 20 mm, for example a width/length of about 10 mm. As a further numerical example, a distance 224 between the corner of the lens array and the border of the substrate 218 may be in the range from 0.1 mm to 10 mm, for example in the range from 0.5 mm to 5 mm, for example about 3 mm.

FIG. 2D shows three exemplary projections 230a, 230b, 230c that may be defined via a suitable structuring of the structured layer 212. The coloring of the projections 230a, 230b, 230c (e.g., a color gradient) may be obtained by suitable configuring and disposing light coloring layers in the optical element 200, as discussed in further detail in relation to FIG. 3A to FIG. 5B.

FIG. 3A shows possible configurations 300a-300e for disposing a light coloring layer in an optical channel 302. The representation in FIG. 3A may be simplified for the purpose of illustration, and shows an individual optical channel 302 with a corresponding lens 304 (e.g., a field lens), as representation of optical channel 202 and first lens 204 discussed in FIG. 2A. It is understood that the aspects discussed in relation to FIG. 3A may extend to more than one optical channel of the optical element 200, e.g. to each optical channel of the optical element 200. It is also understood that the aspects discussed in relation to FIG. 3A may apply in a corresponding manner to a different arrangement of the various components, e.g. a different ordering of the lens 304, structured layer 306, and light coloring layer 310. Further, for clarity of representation the various components are shown separate from one another, but it is understood that the aspects discussed herein may apply in a corresponding manner to the configuration in which the lens 304, structured layer 306, and light coloring layer 310 are in contact with one another (e.g., on the substrate of the optical element).

The first configuration 300a shows the scenario in which the optical channel 302 includes the light coloring layer 310 disposed in a dedicated portion of the optical channel 302. Illustratively, the structured layer 306 may define one or more structured features 308 in correspondence of the optical channel 302 (e.g., first to third structured features 308-1, 308-2, 308-3, as an example, or any suitable number of structured features), and the light coloring layer 310 may be disposed to cover (illustratively, to overlap) part of the structured features 308. For example, the light coloring layer 310 may overlap a first structured feature 308-1 while leaving another (e.g., second) structured feature 308-2 free of the light coloring layer 310. It is understood that the aspects discussed in relation to a configuration in which a light coloring layer covers a structured feature 308-1 while leaving other structured features 308-2, 308-3 free of the light coloring layer may apply in a corresponding manner to the scenario in which the light coloring layer overlaps only a portion of a (single) structured feature while leaving another portion of the structured feature free of the light coloring layer.

In principle, an optical channel 302 may include more than one light coloring layer 310, e.g. to color more than one portion of the partial projection with the same color or with different colors. For example, as shown in the second configuration 300b and third configuration 300c, the optical channel 302 may include a plurality of light coloring layers 310, e.g. first to third light coloring layers 310-1, 310-2, 310-3, or any other suitable number of light coloring layers 310. In general, one optical channel 302 may include more areas with the same coloring filter and/or one optical channel 302 may include more areas with different coloring filters. The (partial) projection projected via one optical channel 302 may thus include areas with different color/wavelength.

Each coloring layer may be disposed to cover a respective (partial) portion of the optical channel 302, e.g. a respective portion of the aperture of the field lens 304. For example, as shown in the second configuration 300b, the optical channel 302 may include a first light coloring layer 310-1 and a second light coloring layer 310-2. As mentioned, the first light coloring layer 310-1 may be disposed to in a dedicated part of the optical channel 302 while leaving the remaining portion of the optical channel 302 free of the first light coloring layer 310-1. In a corresponding manner, the second light coloring layer 310-2 may be disposed to in a dedicated part of the optical channel 302 while leaving the remaining portion of the optical channel 302 free of the second light coloring layer 310-2.

For example, the first light coloring layer 310-1 may cover (only) a first portion of the structured layer 306 in correspondence of the optical channel 302, the second light coloring layer 310-2 may cover (only) a second portion of the structured layer 306 in correspondence of the optical channel 302, a third light coloring layer 310-3 (see configuration 300c) may cover (only) a third portion of the structured layer 306 in correspondence of the optical channel 302, etc. For example, each light coloring layer may overlap with one or more respective structured features 308 (fully, or partially), while leaving other structured features 308 (or other portions of the structured features) free of the light coloring layer (and possibly covered by other light coloring layers).

As an exemplary configuration, the first light coloring layer 310-1 may cover (only) a first structured feature 308-1 (or one or more first structured features), the second light coloring layer 308-2 may cover (only) a second structured feature 308-2 (or one or more second structured features), the third light coloring layer 310-3 may cover (only) a third structured feature 308-3 (or one or more third structured features), etc. In principle, all the structured features 308 corresponding to an optical channel 302 may be covered (fully or partially) with a respective light coloring layer 310, or, in another configuration, at least one structured feature 308 may be free of any light coloring layer 310.

In general, the properties of the light coloring layers 310 may be adapted depending on which color or colors to impose onto the light propagating through the optical channel 302, e.g. to provide the same color for different structured features 308 or to provide different colors for different structured features 308. The first light coloring layer 310-1 may thus be configured to impose a first predefined color onto light passing through the first light coloring layer 310-1, the second light coloring layer 310-2 may be configured to impose a second predefined color onto light passing through the second light coloring layer 310-2, the third light coloring layer 310-3 may be configured to impose a third predefined color onto light passing through the third light coloring layer 310-3, etc.

The various colors may be adapted freely. For example, the first predefined color may be the same as the second predefined color (and/or as the third predefined color, etc.). As another example, the first predefined color may be different from the second predefined color (and/or from the third predefined color, etc.). For example, the first predefined color may be the same as the second predefined color and different from the third predefined color. As another example, the first predefined color may be different from the second predefined color, and the first predefined color and the second predefined color may be different from the third predefined color. Any other suitable combination may be provided depending on the number of light coloring layers 310 in an optical channel 302.

According to various aspects, as shown in the fourth configuration 300d and fifth configuration 300e, an optical channel 302 may include a plurality of light coloring layers 310 stacked over each other. For example, the optical channel 310 may include a light coloring stack with a plurality of light coloring layers, e.g. a first light coloring layer 310-1 and a second light coloring layer 310-2 (or with any suitable number of light coloring layers). The aspects discussed in relation to a single layer may apply in a corresponding manner to the light coloring stack. Illustratively, the light coloring stack may cover only part of the optical channel 302, e.g. only a portion of the structured layer 306 while leaving another portion free of the light coloring stack.

In this configuration, each light coloring layer of the light coloring stack may be configured to provide a respective color, which may be different from the colors defined by the other layers of the stack. A configuration with a light coloring stack may enable a further tailoring of the coloring of the projection, e.g. to define more complex color combinations. As shown in FIG. 3A, the light coloring stack may be provided in the optical channel 302 alone, or in combination with other individual light coloring layers 310-3 in other portions of the optical channel 302, or in combination with other light coloring stacks (not shown).

In principle, each optical channel 302 of the optical element may be adapted according to any suitable configuration depending on the desired appearance of the resulting projection. Each optical channel 302 may thus include any suitable number of light coloring layers or stacks, disposed in any suitable manner according to the target configuration for the resulting projection. Each optical channel 302 may thus be configured according to any of the configurations discussed in relation to FIG. 3A, or according to other possible configurations/dispositions of light coloring layers.

The configurations of different optical channels 302, e.g. in terms of number of light coloring layers, types of colors, position of the light coloring layers, etc. may be adapted according to the target configuration for the resulting projection, e.g. according to the target colors or gradation of colors in the resulting projection obtained by the superposition of the partial projections from the individual optical channels 302. As an exemplary configuration, areas of coloring filter can be different for different optical channels 302. As another exemplary configuration, areas with different coloring filter from different optical channels 302 may be superimposed in the resulting projection, e.g. on the illuminated surface. As a further exemplary configuration, areas with same coloring filter from different optical channels 302 may be superimposed in the resulting projection, e.g. on the illuminated surface.

FIG. 3B shows an exemplary configuration 300f showing a plurality of optical channels 302, e.g. first to third optical channels 302-1, 302-2, 302-3. It is understood that the aspects discussed in relation to FIG. 3B may extend to any suitable number of optical channels. Furthermore, FIG. 3B shows an exemplary configuration in which each optical channel 302-1, 302-2, 302-3 includes a single light coloring layer 310 (e.g., first to third light coloring layers 310a, 310b, 310c) but it is understood that any of the configurations in FIG. 3A may be provided for an optical channel 302 (or any other suitable configuration), e.g. with more than one light coloring layer (defining the same color or different colors), with a light coloring stack, etc.

In general, the light coloring layers 310 in different optical channels 302 may be disposed in correspondence of the same structured feature 308 or different structured features 308 depending on the target coloring to be provided for the resulting projection. In this context, the expression “same structured feature” 308 may refer in general to structured features 308 in correspondence of different optical channels 302 that contribute to the same portion of the resulting projection, illustratively structured features 308 that provide the same projected feature in the resulting projection. Thus, “same structured features” 308 may be equal to one another in different optical channels 302, e.g. in terms of shape, size, relative position, etc. However, “same structured features” 308 may also be slightly different in different optical channels 302 (e.g. in terms of shape, size, relative position) in view of the slight adaptations provided to obtain the resulting projection in the far-field, while still corresponding to the same projected feature in the resulting projection. Thus, “same structured features” 308 in different optical channels 302 may in general be understood as portions of the structured layer 306 in different optical channels 302, whose (partial) projections superimpose with one another upon illumination of the optical element 200 to provide a part of the resulting projection. In a corresponding manner, “different structured features” 308 in different optical channels 302 may in general be understood as portions of the structured layer 306 in different optical channels 302, whose (partial) projections do not superimpose with one another upon illumination of the optical element 200 as they correspond to different portions of the resulting projection.

As shown in the exemplary configuration in FIG. 3B, the first optical channel 302-1 may include a first light coloring layer 310a (or stack), the second optical channel 302-2 may include a second light coloring layer 310b (or stack), the third optical channel 302-3 may include a third light coloring layer 310c (or stack), etc. In an exemplary configuration, each optical channel of the optical element 200 may include at least one light coloring layer. In another configuration, at least one optical channel of the optical element 200 may be free of any light coloring layer.

In an exemplary configuration, the light coloring layers in different optical channels 302 may cover the same structured feature of the structured layer 306. This is shown in FIG. 3B for the first light coloring layer 310a in the first optical channel 302-1 that covers a first structured feature 308-1 (or one or more first structured features), and the second light coloring layer 310b in the second optical channel 302-2 that covers the (same) first structured feature 308-1 (or the same one or more first structured features). The first light coloring layer 310a and the second light coloring layer 310b may be configured to impose the same color on light passing through the layer, or may be configured to impose different colors on light passing through the layer, depending on the desired effect for the resulting projection.

In an exemplary configuration, additionally or alternatively, the light coloring layers in different optical channels 302 may cover different structured feature of the structured layer 306. This is shown in FIG. 3B for the first light coloring layer 310a in the first optical channel 302-1 that covers a first structured feature 308-1 (or one or more first structured features), and the third light coloring layer 310c in the third optical channel 302-3 that covers a different (e.g., second) structured feature 308-2 (or one or more second structured features). The first light coloring layer 310a and the third light coloring layer 310c may be configured to impose the same color on light passing through the layer, or may be configured to impose different colors on light passing through the layer, depending on the desired effect for the resulting projection.

The aspects discussed in relation to the exemplary configuration in FIG. 3B may be extended in a corresponding manner to the scenario in which the optical channels 302 include a plurality of light coloring layers 310. For example, the first optical channel 302-1 may include a first and a second light coloring layer, and the second optical channel 302-2 may include a third and a fourth light coloring layer. The first light coloring layer may cover the same structured features as the third light coloring layer, and may define the same color or a different color as the third light coloring layer. The second light coloring layer may cover the same structured features as the fourth light coloring layer, and may define the same color or a different color as the fourth light coloring layer (and the same color or a different color as the first/third light coloring layers), etc.

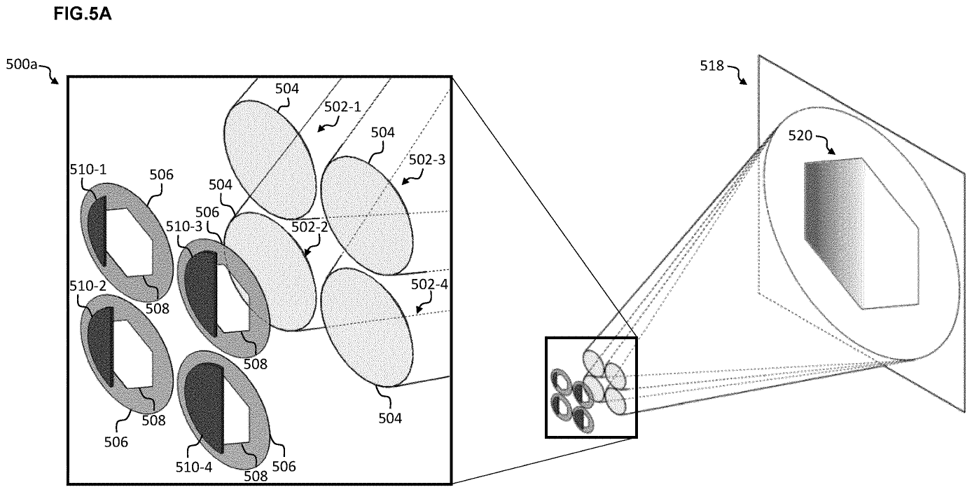

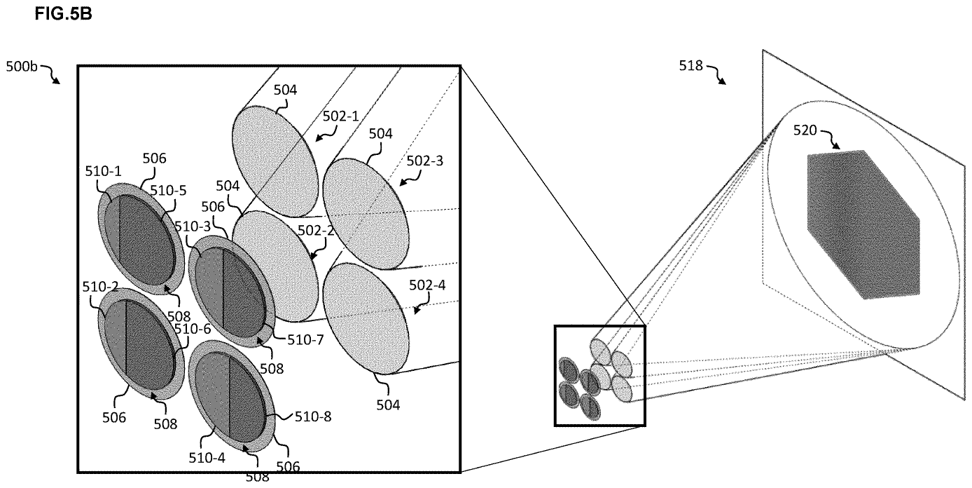

According to various aspects (see also FIG. 5A to FIG. 5B), the light coloring layers 310 may be configured to define a color gradient in the resulting projection. Illustratively, the light coloring layers 310 may be disposed in different optical channels 302 to create a color gradient (e.g., from white light to a certain color, or from an initial color to a final color) in the resulting projection obtained via the optical element. A “color gradient” may be understood as a gradual variation (e.g., increase or decrease) in the color (e.g., in terms of intensity) along the extension of the resulting projection, e.g., in the vertical direction and/or horizontal direction.

The color gradient may be obtained by varying the extension of the structured layer 306 (e.g., of the structured features 308) covered by the light coloring layers 310 in different optical channels. This may be achieved, for example, by varying the size of the light coloring layers 310 in different optical channels 302 or by shifting the position of light coloring layers 310 in different optical channels 302 to cover more or less area of the structured features 308. This way the superposition of light projected via the different optical channels 302 may gradually vary depending on how many light coloring layers 310 overlap with the openings through which the light propagates.

For example, with reference to the configuration in FIG. 3B, a color gradient may be achieved by adapting the first light coloring layer 310a in the first optical channel 302-1 and the second light coloring layer 310b in the second optical channel 302-2 to cover a different amount of the surface area corresponding to the first structured feature 308-1 (or first structured features). For example, the first light coloring layer 310a may fully cover the first structured feature 308-1 in the first optical channel 302-1, and the second light coloring layer 310b may cover only part of the first structured feature 308-1 in the second optical channel 302-2 (e.g., 90% of the surface area of the first structured feature 308-1). A further light coloring layer 310 in a further optical channel may cover even less of the first structured feature 308-1 in the further optical channel 302 (e.g., 80% of the surface area), and so on, depending on the desired color gradient.

As mentioned, a color gradient may be achieved from an initial color to a final color, e.g. from white light (or in general the color of the light source) to the color defined by the light coloring layers, or from one first color to a second color. A color gradient from the color of the light emitted by the light source to a predefined color may be achieved by leaving the surface area of the structured features not covered by the light coloring layer free from any (further) light coloring layer, so that the light emitted by the light source may propagate unaffected. A color gradient from one first color to a second color (with or without intermediate colors) may be achieved by covering e surface area of the structured features not covered by the light coloring layer (defining the first color) with another light coloring layer (defining the second color). In this second scenario, the surface area covered by the first type of light coloring layers (defining the first color) may gradually increase (or decrease), and the surface area covered by the second type of light coloring layers (defining the second color) may gradually decrease (or increase) across different optical channels 302.

For example, with reference to the configuration in FIG. 3B, a color gradient may be achieved by having in the first optical channel 302-1 a first light coloring layer defining a first color and covering part of the first structured feature 308-1 (e.g., 50% of the surface area), and a second light coloring layer defining a second color and covering another part of the first structured feature 308-1 (e.g., a complementary portion of the surface area, e.g. the other 50%). Further, the color gradient may be achieved by having in the second optical channel 302-2 a third light coloring layer defining the first color and covering part of the first structured feature 308-1 (e.g., more or less surface area compared to the first light coloring layer, for example 40% of the surface area), and a fourth light coloring layer defining the second color and covering another part of the first structured feature 308-1 (e.g., a complementary portion of the surface area, e.g. more or less surface area compared to the second light coloring layer, for example 60% of the surface area). These aspects may be extended to further light coloring layers in further optical channels covering more/less surface area of the structured features. These aspects may also be extended to more than two light coloring layers used for creating the gradient corresponding to a structured feature.

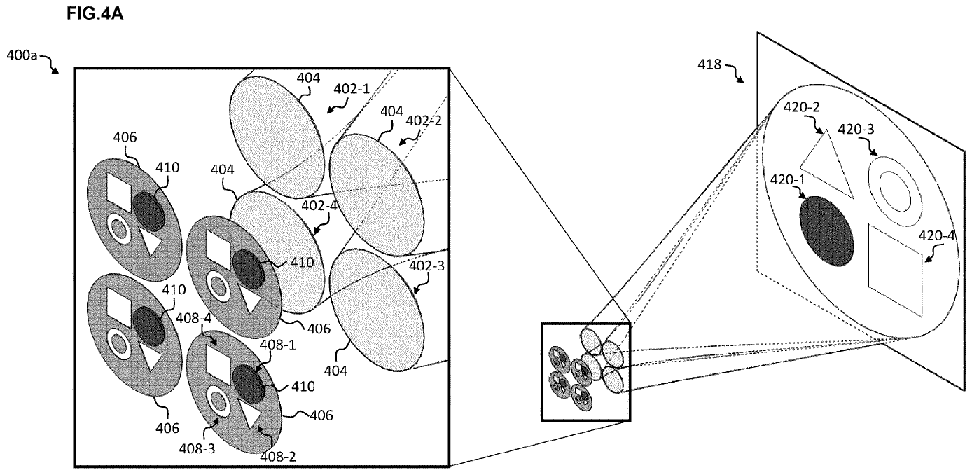

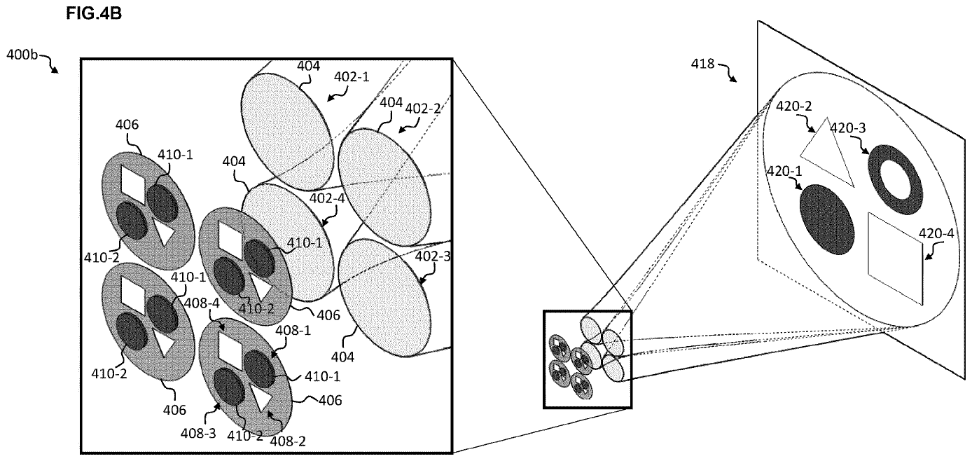

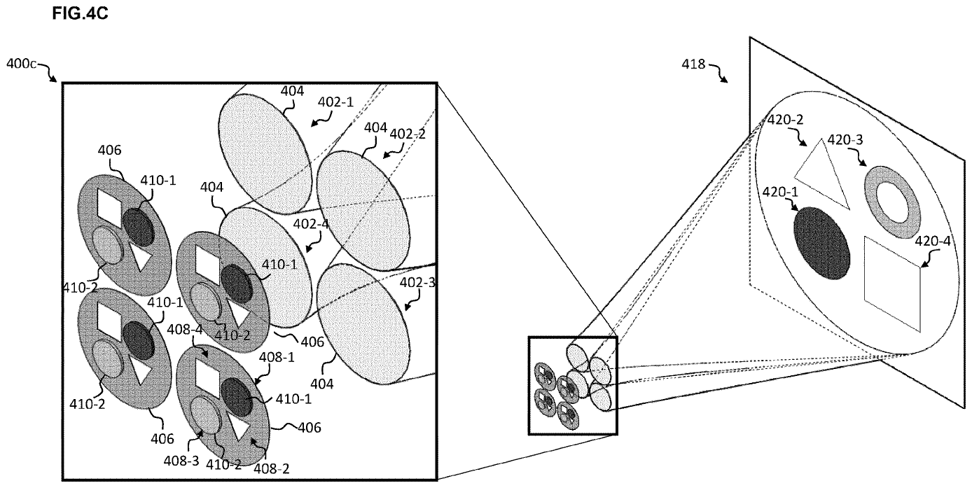

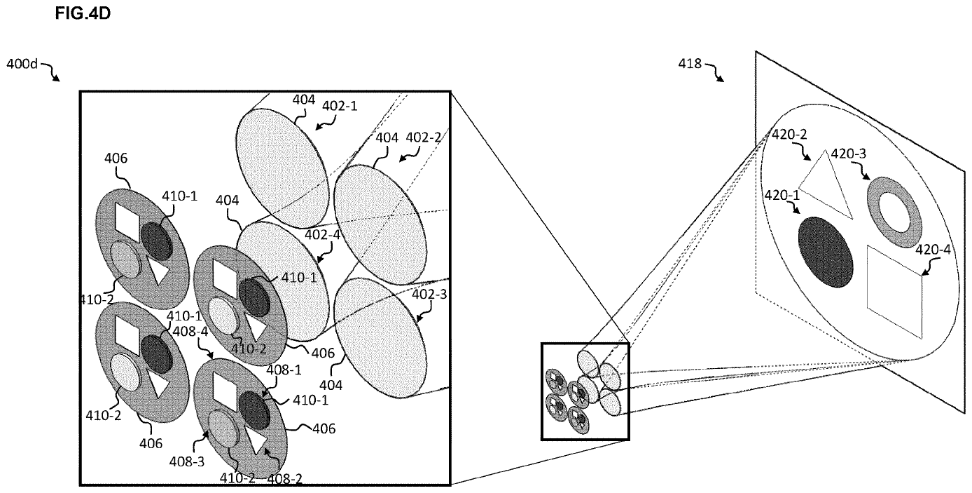

FIG. 4A to FIG. 4D show exemplary configurations for light coloring layers in different optical channels of a multi-lens optical element. FIG. 4A to FIG. 4D illustrate exemplary implementations of the configurations discussed in relation to FIG. 3A and FIG. 3B. It is understood that the representation in FIG. 4A to FIG. 4D are simplified for the purpose of illustration and that the optical elements shown therein may include further components as discussed in relation to FIG. 2A (e.g., field lenses, a substrate, etc.).

The exemplary configurations in FIG. 4A to FIG. 4D illustrate possible coloring over four optical channels 402-1, 402-2, 402-3, 402-4 defined by a respective imaging lens 404 (and a corresponding field lens, not shown). Illustratively, FIG. 4A to FIG. 4D illustrate possible dispositions of light coloring layers 410 with respect to the structuring of the structured layer 406 that defines the resulting projection 418. The structured layer 406 may include structured features 408-1, 408-2, 408-3, 408-4 that define the projection 418 in the far-field (e.g., on a projecting surface, such as a wall, a road, a windshield, a floor, etc.). Each structured feature 408-1, 408-2, 408-3, 408-4 may generate a corresponding projected feature 420-1, 420-2, 420-3, 420-4 in the resulting projection 418. In general, a structured feature may have any suitable configuration (e.g., shape, size, geometry, etc.) depending on the resulting projection to be obtained. In the exemplary configurations in FIG. 4A to FIG. 4D the structured features are illustrated as geometric shapes, but it is understood that a structured feature may have any possible design.

In the exemplary configuration 400a in FIG. 4A, the optical channels 402-1, 402-2, 402-3, 402-4 may each include a light coloring layer 410 disposed in correspondence of the same structured feature (e.g., the first structured feature 408-1). In this scenario, the corresponding projected feature 420-1 in the resulting projection 418 may be colored according to the color defined by the light coloring layer 410 (e.g., assuming that the light coloring layers 410 in different optical channels define the same color). Since the light coloring layer 410 leaves the remaining portion of the optical channel (and thus the other structured features 408-2, 408-3, 408-4) free of the light coloring layer 410, the remaining part of the projection 418 (the other projected features 420-2, 420-3, 420-4) may be free from the color defined by the light coloring layer 410 (e.g., may have the color of the light emitted by the light source, e.g. white).

In the exemplary configuration 400b in FIG. 4B, the optical channels 402-1, 402-2, 402-3, 402-4 may each include a plurality of light coloring layers, e.g. a first light coloring layer 410-1 in correspondence of the first structured feature 408-1, and a second light coloring layer 410-2 in correspondence of the third structured feature 408-3. In this scenario, the corresponding projected featured 420-1 in the resulting projection 418 may be colored according to the color defined by the light coloring layers 410-1, 410-2. The first projected feature 420-1 may thus be colored according to the color defined by the first light coloring layers 410-1, and the third projected feature 420-3 may be colored according to the color defined by the second light coloring layers 410-2. The other projected features 420-2, 420-4 may be free from the color defined by the light coloring layers 410-1, 410-2.

In the configuration 400b in FIG. 4B the light coloring layers 410-1, 410-2 may be configured to impose the same color to light, so that the corresponding projected features 420-1, 420-3 may have the same color. In the configuration 400c in FIG. 4C, on the other hand, the light coloring layers 410-1, 410-2 may be configured to impose different colors to light, so that the corresponding projected features 420-1, 420-3 may have different colors.

In a slightly more complex configuration 400d in FIG. 4D, the light coloring layers that correspond to the same structured feature in different optical channels may define different colors, thus providing a color resulting from the combination of the individual colors in the resulting projected feature. For example, the first light coloring layers 410-1 in the different optical channels 402-1, 402-2, 402-3, 402-4 may define the same (first) color, so that the resulting projected feature 420-1 is colored accordingly. The second light coloring layers 410-2 disposed in correspondence of the third structured feature 408-3 may define different colors in different optical channels. For example, the second light coloring layer 410-2 in the second optical channel 402-2 and fourth optical channel 402-4 may define a second color (e.g., yellow), and the second light coloring layer 410-2 in the first optical channel 402-1 and third optical channel 402-3 may define a third color different from the second color (e.g., blue). The resulting (third) projected feature may have a fourth color (e.g., green) resulting from the combination of the second color and third color. Such approach may be extended to any suitable number of colors to provide a desired tone in the projection 418.

FIG. 5A and FIG. 5B show exemplary configurations for light coloring layers in different optical channels of a multi-lens optical element. FIG. 5A to FIG. 5D illustrate exemplary implementations of the configurations discussed in relation to FIG. 3A and FIG. 3B, in particular in relation to a configuration of the light coloring layers to achieve a color gradient in the resulting projection. It is understood that the representation in FIG. 5A and FIG. 5B are simplified for the purpose of illustration and that the optical elements shown therein may include further components as discussed in relation to FIG. 2A (e.g., field lenses, a substrate, etc.).

The exemplary configurations in FIG. 5A and FIG. 5B illustrate possible coloring over four optical channels 502-1, 502-2, 502-3, 502-4 defined by a respective imaging lens 504 (and a corresponding field lens, not shown). Illustratively, FIG. 5A and FIG. 5B illustrate possible dispositions of light coloring layers with respect to the structuring of the structured layer 506 that defines the projection 518. The structured layer 506 may include a structured feature 508 that defines the projection 518 in the far-field (e.g., on a projecting surface, such as a wall, a road, a windshield, a floor, etc.). The structured feature 508 may generate a corresponding projected feature 520 in the resulting projection 518. It is understood that the aspects discussed in relation to FIG. 5A and FIG. 5B may apply in a corresponding manner to a configuration with more than one structured feature per optical channel.

In the exemplary configuration 500a in FIG. 5A, the optical channels 502-1, 502-2, 502-3, 502-4 may each include a light coloring layer 510-1, 510-2, 510-3, 510-4 disposed in correspondence of the (same) structured feature 508, and the light coloring layers 510-1, 510-2, 510-3, 510-4 in different optical channels 502-1, 502-2, 502-3, 502-4 may cover a different portion of the structured feature 508 (illustratively, a different amount of surface area). For example, the light coloring layers 510-1, 510-2, 510-3, 510-4 may define the same color for the light passing through the layer.

Illustratively, the first light coloring layer 510-1 may cover a first surface area of the structured feature 508 in the structured layer 506 in correspondence of the first optical channel 502-1, the second light coloring layer 510-2 may cover a second surface area of the structured feature 508 in the structured layer 506 in correspondence of the second optical channel 502-2, the third light coloring layer 510-3 may cover a third surface area of the structured feature 508 in the structured layer 506 in correspondence of the third optical channel 502-3, and the fourth light coloring layer 510-4 may cover a fourth surface area of the structured feature 508 in the structured layer 506 in correspondence of the fourth optical channel 502-4, etc.

In the exemplary configuration 500a in FIG. 5A, the first surface area covered by the first light coloring layer 510-1 may be less than the second surface area covered by the second light coloring layer 510-2, the second surface area may be less than the third surface area covered by the third light coloring layer 510-3, and the third surface area may be less than the fourth surface area covered by the fourth light coloring layer 510-4. This configuration allows obtaining a color gradient in the projected feature 520 from the color of the light source (e.g., white) in correspondence of the portions of the structured feature 508 not covered by any light coloring layer, to the color defined by the light coloring layer in correspondence of the portions of the structured feature 508 covered by the light coloring layer. The variation may be gradual depending on the number of light coloring layers that cover that particular portion of the structured feature 508 in the various optical channels 502.

In the exemplary configuration 500b in FIG. 5B, the color gradient may be from an initial (first) color to a final (second) color defined by a plurality of light coloring layers covering the structured feature 508 in each optical channel 502-1, 502-2, 502-3, 502-4. For example, in addition to the light coloring layers 510-1, 510-2, 510-3, 510-4 described in relation to FIG. 5A, the optical channels 502-1, 502-2, 502-3, 502-4 may include a further light coloring layer to cover the complementary portion of the structured feature 508 rather than leaving such portion free of any colored layer.

Illustratively, the first optical channel 502-1 may further include a fifth light coloring layer 510-5 disposed to cover a fifth surface area of the structured feature 508 in the structured layer 506 in correspondence of the first optical channel 502-1 (e.g., complementary to the first surface area with respect to a total surface area of the structured feature 508). The second optical channel 502-2 may further include a sixth light coloring layer 510-6 disposed to cover a sixth surface area of the structured feature 508 in the structured layer 506 in correspondence of the second optical channel 502-2 (e.g., complementary to the second surface area with respect to a total surface area of the structured feature 508). The third optical channel 502-3 may further include a seventh light coloring layer 510-7 disposed to cover a seventh surface area of the structured feature 508 in the structured layer 506 in correspondence of the third optical channel 502-3 (e.g., complementary to the third surface area with respect to a total surface area of the structured feature 508). The fourth optical channel 502-2 may further include an eighth light coloring layer 510-8 disposed to cover an eighth surface area of the structured feature 508 in the structured layer 506 in correspondence of the fourth optical channel 502-4 (e.g., complementary to the fourth surface area with respect to a total surface area of the structured feature 508).

In the exemplary configuration 500b in FIG. 5B, the fifth surface area covered by the fifth light coloring layer 510-5 may be greater than the sixth surface area covered by the sixth light coloring layer 510-6, the sixth surface area may be greater than the seventh surface area covered by the seventh light coloring layer 510-7, and the seventh surface area may be greater than the eighth surface area covered by the eighth light coloring layer 510-8. This configuration allows obtaining a color gradient in the projected feature 520 from the color of the second type of light coloring layers (fifth to eighth) to the color of the first type of light coloring layers (first to fourth), or vice versa. As mentioned above, such configuration may be extended to any suitable number of colors to be provided in the gradient.

FIG. 6 shows a projection system 600 including a multi-lens optical element 602 configured as described herein in a schematic representation, according to various aspects. The multi-lens optical element 602 may be configured according to any of the configurations discussed in relation to FIG. 2A to FIG. 5B to provide a colored projection. The projection system 600 may be integrated in any suitable host device depending on the desired application. As an example, the projection system 600 may be integrated in a vehicle (e.g., in a door of the vehicle, in a headlamp, etc.). In principle, the proposed approach may be applied to any platform.

The projection system 600 may include a light source 604 configured to illuminate the multi-lens optical element 602 to generate a projection 610 in the far-field, e.g. on a projecting surface. Illustratively, the light source 604 may illuminate the multi-lens optical element 602 to project an image via a superposition of the partial projections defined by the optical channels (e.g., defined by the structured layer in correspondence of the optical channels). It is understood that the projection system 600 may include more than one light source for illuminating the multi-lens optical element 602, e.g. a plurality of light sources each emitting light having a different color.

In general, the light source 604 may be configured to emit collimated light. The light source 604 may have any suitable configuration capable of illuminating the multi-lens optical element 602 and generate the projection 610. For example, the light source 604 may be or include a light-emitting diode (LED), e.g. an array of light-emitting diodes for example arranged in a one-dimensional fashion or a two-dimensional fashion. As another example, the light source may be or include a laser source, e.g. a Vertical Cavity Surface Emitting Laser (VCSEL) or a VCSEL-array. The light source may be configured to emit light having a predefined wavelength, for example in the visible range (e.g., from about 380 nm to about 700 nm). As other examples, the light source may be configured to emit light in the infrared and/or near-infrared range (e.g., in the range from about 700 nm to about 5000 nm), or ultraviolet range (e.g., from about 100 nm to about 400 nm). As an example, the light source 604 may be configured to emit white light, but it may in principle be configured to emit light having a different color. The light source 604 may be configured to emit light in any suitable manner depending on the desired operation of the projection system 600. As an example, the light source 604 may emit continuous light. As another example, the light source 604 may emit light in a pulsed manner, e.g. the light source 604 may emit a sequence of light pulses.

The projection system 600 may further include a control circuit 606 (e.g., one or more processors) configured to control the light emission by the light source 604. The control circuit 606 may be configured to trigger the light emission by the light source 604 and an interruption of light emission by the light source 604. As an example, the control circuit 606 may be configured to trigger the light emission by the light source 604 in response to a predefined trigger event. The control circuit 606 may receive a signal representing the occurrence of the trigger event (a vehicle-related trigger event) and may control the light source 604 to emit light accordingly to generate the projection 610.

A trigger event may correspond to any suitable scenario in which the projection 610 should be generated. As an example, a (vehicle-related) trigger event may be the opening of the door of a vehicle, e.g. to trigger projection of a welcome pattern for the driver. As another example, a (vehicle-related) trigger event may be the approaching of a driver/passenger to a vehicle (e.g., as detected by a proximity sensor). As a further example, a (vehicle-related) trigger event may be the detection of a malfunction of the vehicle, or the detection of a potentially dangerous situation (e.g., an excessive speed, a slippery road, a traffic jam, etc.). It is understood that these are exemplary trigger events for the automotive context, but other types of trigger events may be provided (e.g., the opening of the door of a refrigerator, a variation in the temperature of a room, a task being completed by a robot, etc.).

The strategy proposed herein may thus rely on a localized coating in the optical channels of a multi-lens optical component. The colored coating may be present just for a dedicated local area within each optical channel, and may be different for each optical channel. In some aspects, the coating may be disposed close to the display area, e.g. as part of the base layer of a lens.

Different configurations may be provided. In a configuration with a “one color local coating”, a local transparent colored coating may be provided for at least for one optical channel. In a configuration with “more colors local coating”, each optical channel may include one or more areas of local coating with same or different colors, and the colors may be superimposed in the final (resulting) projection.

In various aspects, a color gradient projection may be provided. The local coating may be designed for each channel (or for at least two channels) separately to create transition from color to white light (or, in general, light defined by the light source). In another configuration, the local coating may be designed for each channel (or for at least two channels) separately to create transition from one color to another color. Also multiple transitions or color superimpositions are possible. A smooth gradient (transition) between multiple colors or between color and white light may thus be obtained. For example the gradient may be realized via a progressive variation in the size of the coating area to create transition between colors, or between color and white light.

The proposed approach may be applied for decorative and functional projections, such as symbols, warning symbols, graphic projections, pattern projections, etc. The proposed approach may find use, for example, in the automotive market, industrial market, or consumer market.

The proposed approach allows creating a colored gradient with a white light source (e.g., a LED), and allows changing the projected color without changing of light source (so that a standard module may be used). Illustratively, the proposed approach enables a RGB projection done by a white light source.

Thus, according to the proposed approach colored coating is done just for dedicated local area within each optical channel (e.g., within the base layer of the field lens), and each optical channel may include different coating-color or particular area. As an example, the coating may be realized via colored resin (e.g., a colored epoxy). The local color coating provided within one optical channel allows to create transition between color and white light or between two different colors. The local coating allows to use also more colors within one optical channel or color mixing between more optical channels. The local coating within one optical channel allows to project just local part or parts of projected pattern/graphic/display colored by one or more colors.

The term “control circuit” (or processing circuit) as used herein may be understood as any kind of technological entity that allows handling of data. The data may be handled according to one or more specific functions that the control circuit may execute. Further, a control circuit as used herein may be understood as any kind of circuit, e.g., any kind of analog or digital circuit. A control circuit may thus be or include an analog circuit, digital circuit, mixed-signal circuit, logic circuit (e.g., a hard-wired logic circuit or a programmable logic circuit), microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof.

The word “exemplary” is used herein to mean “serving as an example, instance, or illustration”. Any embodiment or design described herein as “exemplary” is not necessarily to be construed as preferred or advantageous over other embodiments or designs.

The phrase “at least one” and “one or more” may be understood to include a numerical quantity greater than or equal to one (e.g., one, two, three, four, [. . . ] , etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

All acronyms defined in the above description additionally hold in all claims included herein.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

### List of Reference Signs

100 Projecting optical element
102 Optical channel
104 Field lens
106 Imaging lens
108 Optical substrate
110 Projection mask
112 Projection
114 Projecting surface
200 Multi-lens optical element
202 Optical channel
204 First lens
206 Second lens
208 First plurality of lenses
210 Second plurality of lenses
212 Structured layer
214 Structured feature
216 Light coloring layer
218 Optical substrate
220 First dimension
222 Second dimension
224 Third dimension
230a First projection
230b Second projection
230c Third projection
300a First configuration
300b Second configuration
300c Third configuration
300d Fourth configuration
300e Fifth configuration
300f Sixth configuration
302 Optical channel
302-1 First optical channel
302-2 Second optical channel
302-3 Third optical channel
304 Lens
306 Structured layer
308 Structured features
308-1 First structured feature
308-2 Second structured feature
308-3 Third structured feature
310 Light coloring layer
310-1 First light coloring layer
310-2 Second light coloring layer
310-3 Third light coloring layer
310a First light coloring layer
310b Second light coloring layer
310c Third light coloring layer
400a First configuration
400c Third configuration
400d Fourth configuration
402-1 First optical channel
402-2 Second optical channel
402-3 Third optical channel
402-4 Fourth optical channel
404 Imaging lens
406 Structured layer
408-1 First structured feature
408-2 Second structured feature
408-3 Third structured feature
408-4 Fourth structured feature
410 Light coloring layer
410-1 First light coloring layer
410-2 Second light coloring layer
418 Projection
420-1 First projected feature
420-2 Second projected feature
420-3 Third projected feature
420-4 Fourth projected feature
500a First configuration
500b Second configuration
502-1 First optical channel
502-2 Second optical channel
502-3 Third optical channel
502-4 Fourth optical channel
504 Imaging lens
506 Structured layer
508 Structured feature
510-1 First light coloring layer
510-2 Second light coloring layer
510-3 Third light coloring layer
510-4 Fourth light coloring layer
510-5 Fifth light coloring layer
510-6 Sixth light coloring layer
510-7 Seventh light coloring layer
510-8 Eighth light coloring layer
510-1 First light coloring layer
510-2 Second light coloring layer
510-3 Third light coloring layer
510-4 Fourth light coloring layer
518 Projection
520 Projected feature
600 Projection system
602 Optical element
604 Light source
606 Control circuit
610 Projection

1. A multi-lens optical element comprising:
a plurality of optical channels,
wherein each optical channel is defined by a corresponding field lens and a corresponding imaging lens;
a structured layer configured to define for each optical channel partial projection to be projected via the optical channel to obtain a resulting projection via a superposition of the partial projections from the plurality of optical channels; and
a light coloring layer disposed in at least one optical channel of the plurality of optical channels,
wherein the light coloring layer is disposed to cover a first portion of the structured layer in correspondence of the at least one optical channel and leave a remaining portion of the structured layer in correspondence of the at least one optical channel free of the light coloring layer, and
wherein the light coloring layer is configured to impose a predefined color on light passing through the light coloring layer.

2. The multi-lens optical element according to claim 1,
wherein the structured layer in correspondence of the at least one optical channel comprises a plurality of structured features configured to define the partial projection, and
wherein the light coloring layer is disposed to cover one or more structured features of the plurality of structured features while leaving one or more other structured features of the plurality of structured features free of the light coloring layer.

3. The multi-lens optical element according to claim 1,
wherein the structured layer in correspondence of the at least one optical channel comprises one or more structured features configured to define the partial projection, and
wherein the light coloring layer is disposed to overlap a portion of one of the structured features while leaving another portion of the structured feature free of the light coloring layer.

4. The multi-lens optical element according to claim 1,
wherein the light coloring layer is a color filter configured allow light with wavelength in a predefined wavelength range to pass through the light coloring layer while blocking light with wavelength outside of the predefined wavelength range.

5. The multi-lens optical element according to claim 1,
further comprising a second light coloring layer disposed in the at least one optical channel,
wherein the second light coloring layer is disposed to cover a second portion of the structured layer in correspondence of the at least one optical channel.

6. The multi-lens optical element according to claim 5,
wherein the second light coloring layer is configured to impose a second predefined color on light passing through the second light coloring layer different from the predefined color defined by the light coloring layer; or
wherein the second light coloring layer is configured to impose a second predefined color on light passing through the second light coloring layer equal to the predefined color defined by the light coloring layer.

7. The multi-lens optical element according to claim 1, further comprising:
a further light coloring layer disposed in at least one further optical channel of the plurality of optical channels,
wherein the further light coloring layer is disposed to cover a further first portion of the structured layer in correspondence of the at least one further optical channel and leave a further remaining portion of the structured layer in correspondence of the at least one further optical channel free of the further light coloring layer,
wherein the further light coloring layer is configured to impose a further predefined color on light passing through the further light coloring layer.

8. The multi-lens optical element according to claim 7,
wherein the predefined color imposed by the light coloring layer is the same as the further predefined color imposed by the further light coloring layer; or
wherein the predefined color imposed by the light coloring layer is different from the further predefined color imposed by the further light coloring layer.

9. The multi-lens optical element according to claim 7,
wherein the structured layer defines a structured feature in correspondence of the at least one optical channel and a further structured feature in correspondence of the further optical channel,
wherein the structured feature and the further structured feature correspond to a same projected feature in the resulting projection,
wherein the light coloring layer is disposed to cover a first surface area of the structured feature in correspondence of the at least one optical channel,
wherein the further light coloring layer is disposed to cover a second surface area of the further structured feature in correspondence of the further optical channel, and
wherein the first surface area is different from the second surface area.

10. The multi-lens optical element according to claim 9,
wherein the light coloring layer is disposed to fully cover the structured feature in correspondence of the at least one optical channel, and
wherein the further light coloring layer is disposed to cover a portion of the further structured feature in correspondence of the further optical channel while leaving another portion of the further structured feature free of the further light coloring layer.

11. The multi-lens optical element according to claim 9,
wherein the first surface area and the second surface area define complementary portions of a total surface area of the structured feature.

12. The multi-lens optical element according to claim 1,
wherein the multi-lens optical element comprises a first array of microlenses as field lenses; and
wherein the multi-lens optical element comprises a second array of microlenses as imaging lenses.

13. A projection system comprising:
the multi-lens optical element according to claim 1, and
a light source configured to illuminate the multi-lens optical element to obtain the resulting projection via the superposition of the respective partial projections defined by structured layer for the optical channels of the multi-lens optical element.

14. The projection system according to claim 13,
wherein the light source is configured to emit white light.

15. The projection system according claim 13, further comprising:
a control circuit configured to control a light emission by the light source, and
wherein the control circuit is configured to trigger the light emission by the light source in response to a predefined vehicle-related trigger event.
